(19) United States
(12) Patent Application Publication
(10) Pub. No.: US 2012/0296862 A1
(43) Pub. Date: Nov. 22, 2012

(54) METHOD AND APPARATUS FOR ANALYZING AND MIGRATING DATA INTEGRATION APPLICATIONS

(75) Inventors: Dawid Duda, Zielonki (PL); Jeffrey T. Pascoe, Farmington, MI (US); Wojciech Matyjewicz, Tarnow (PL); Krzysztof Maziarz, Krakow (PL)

(73) Assignee: COMPACT SOLUTIONS, LLC, Oakbrook Terrace, IL (US)

(21) Appl. No.: 13/475,155

(22) Filed: May 18, 2012

Related U.S. Application Data
(60) Provisional application No. 61/488,123, filed on May 19, 2011.

(51) Int. Cl. G06F 17/30

(52) U.S. Cl. 707/602; 707/E17.005

(57) ABSTRACT

An automatic data integration process analysis and conversion is disclosed. The input may be formatted as Extract Load Transform (ELT) or Extract Transform Load (ETL), or any other type of input. The processes may then be analyzed and different outputs generated in a format requested by the user.

### FIELD OF INVENTION

The present invention relates to a method of migrating and analyzing applications for moving data and performing transformations between data assets like databases, data files, and the like. More particularly, the present invention relates to a series of steps that can be executed to analyze the data movement and/or data transformation application and apply this knowledge at a subsequent time.

### SUMMARY AND BACKGROUND OF INVENTION

Data integration applications or processes typically utilize specialized computer programs that perform data movement and transformations between data assets like databases, data files etc. In most cases, those applications are implemented using one of two approaches:
ETL (Extract, Transform, Load). This approach uses dedicated data integration platforms like IBM Data Stage (formerly Ascential), Informatica Power Center, Talend Open Studio/Talend Enterprise Data Integration, etc. The data integration application takes the form of special programs (called Jobs in Data Stage and Talend Open Studio/Talend Enterprise Data Integration, Mappings in Informatica, etc.), implemented usually in a graphical way, that describe where to take the data from, how to process the data and where to load it.
ELT (Extract, Load, Transform). In this approach the data is being loaded to the target data base in the original form and then transformed inside the database using SQL queries.

Metadata is information about data. In the data integration context metadata describes the physical and logical data assets (like data sets, data files, database tables, database columns and their data types) as well as the data processing functions and parameters (e.g. total cost is sum of net cost and tax, cost over week is aggregation of costs over day grouped by the week number).

Companies have more and more complex data integration infrastructures, often consisting of several data integration platforms and a variety of BI (business intelligence) tools. The growing complexity of the data movement processes generates new challenges. The challenges include determining where a value may come from and where a value may be used. A manual approach of analyzing all the processes in the various used integration platforms would take an enormous amount of time. There is a need to capture and store all the metadata about data processing in the whole organization in a single metadata repository. However, extraction of the metadata and converting it into a form required by the single metadata repository is a complex process and usually has to be performed separately for every single data integration platform that is going to be supported by the repository. What is needed is a technology that could automatically analyze metadata processes from different integration platforms.

Once organizations make decisions to optimize their data integration processes by consolidating on a single (or few) data integration platform(s), they typically then face the challenge of a large migration project. Such projects, usually performed by manually reviewing every single data integration process and creating its functional equivalent in the target platform, are risky, costly and time consuming. Again, a technology of scalable automatic analysis of data integration processes that would support the migration could be used to reduce the risk, cost and time related to such a project.

To address those needs, the present disclosure provides an automatic data integration process analysis and conversion. As discussed in detail below, the input may be different types of ETL (DataStage, Informatica etc.), as well as ELT (various types of SQL) data integration processes, or any other type of technology that is used to transform and integrate data. The processes may then be analyzed and different outputs generated, including ETL jobs, SQL scripts, documentation, and metadata, in a format needed for the particular metadata repository, etc.

The present disclosure relates to one or more of the following features, elements or combinations thereof. A data integration process (such as ETL, ELT, BI, or the like) description is parsed and a common representation is extracted. Optionally, additional transformations and/or optimizations may be applied to the extracted information. Then, depending on the user's requirements, an output may be generated, such as a target process/documentation/metadata, etc.

Additional features of the disclosure will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a general flow overview for a typical application of the invention presented herein.

FIG. 2 is an example of common metadata format with different types of components showing component level (FIG. 2A) as well as field level (FIG. 2B).

FIG. 3 is an example of input SQL source (FIG. 3A), appropriate common metadata format (FIG. 3B), one possible output—extracted metadata (FIG. 3C) and another example output—automatically generated documentation (FIG. 3D).

FIG. 4 is an example of input Informatica mapping (FIG. 4A), appropriate common metadata format (FIG. 4B) and one possible output—IBM DataStage job (FIG. 4C).

### DETAILED DESCRIPTION OF THE DRAWINGS

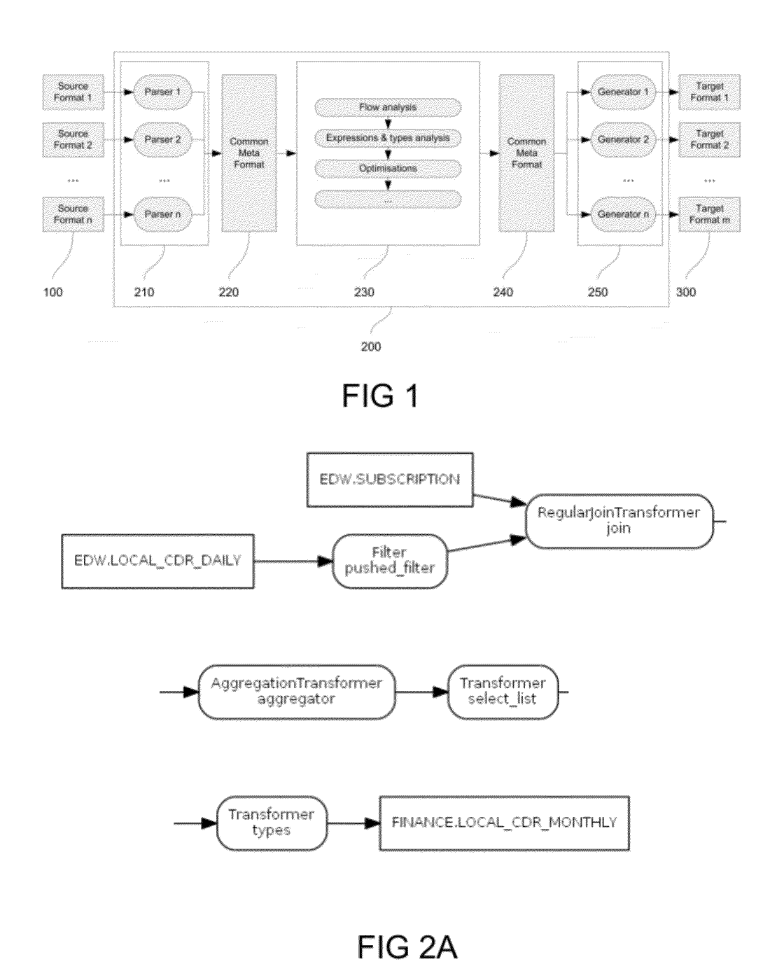

According to one embodiment of the present invention, shown in FIG. 1, a method and apparatus 200 for analyzing and migrating data integration applications is provided. In a first step different source formats 100 are parsed using dedicated parsing modules 210 and the metadata relating to any data processing application is converted to a common metadata format object 220. In a further step 230, a set of useful transformations can be optionally applied to the application metadata such as further analysis or optimizations, resulting in creation of modified metadata format object 240. Thereafter, one of the target format specific generator modules 250 is used to generate proper output format 300. One advantage is the use of a single common metadata format instead of multiple types of formats. The method and apparatus provide other significant advantages in compatibility and significant advantages in efficiency of the solution implementation process.

The common metadata format represents different integration applications using a common set of components, including, for example:
input/output table(s) representing database tables an application reads from/writes to like Connectors in IBM Data Stage, Source/Target Definitions in Informatica Power Center or database tables referenced in a SQL statement;
input/output file(s) representing files an application reads from/writes to, which includes classic files as well as proprietary file structures commonly used to improve performance of parallel processing like Data Sets in IBM DataStage;
join(s) representing joining independent data streams like Join Stage in IBM DataStage, Joiner Transformation in Informatica Power Center or JOIN keyword in SQL;
aggregation(s) representing data aggregation operation like Aggregator Stage in IBM Data Stage, Aggregator Transformation in Informatica Power Center or aggregation functions (SUM, MAX, MIN/GROUP BY etc.) in SQL;
transformation(s) representing data manipulation operations like Transformer Stage in IBM Data Stage, Expression Transformation in Informatica Power Center or expressions in the select list of a SQL statement;
lookup(s) representing lookup operation like Lookup Stage in IBM Data Stage or Lookup Transformation in Informatica Power Center;
sort(s) representing sorting data operation like Sort Stage in IBM DataStage, Sorter Transformation in Informatica Power Center or ORDER BY clause in SQL;
merge(s) representing merging independent data flows like Merge Stage in IBM DataStage, Merger Transformation in Informatica Power Center or UNION clause in SQL and/or,
generic component(s) representing arbitrary logic that cannot be represented using other dedicated components like Generic Stage in IBM DataStage or Custom Transformation in Informatica Power Center.

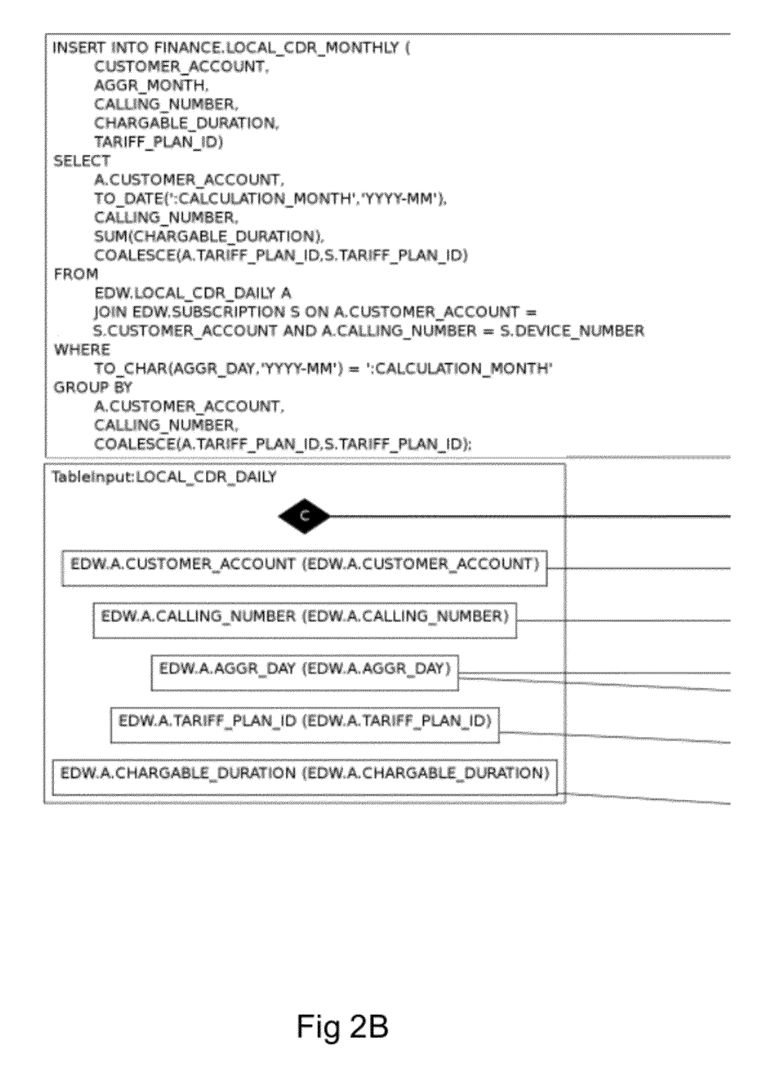

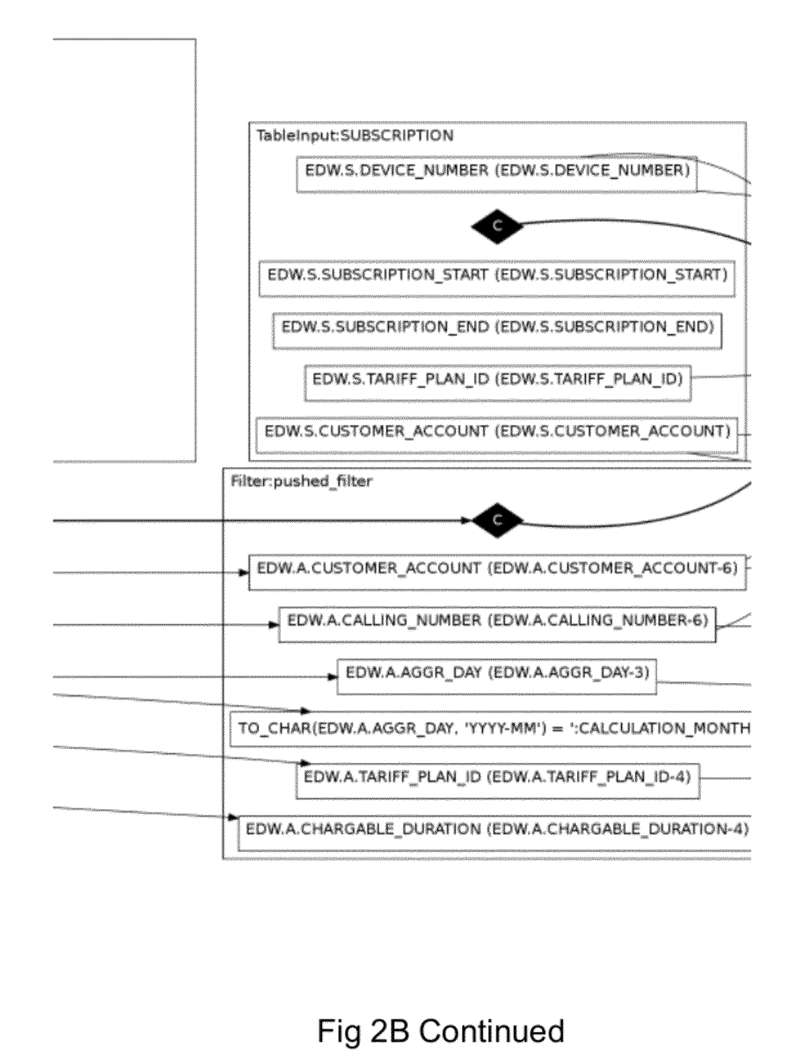

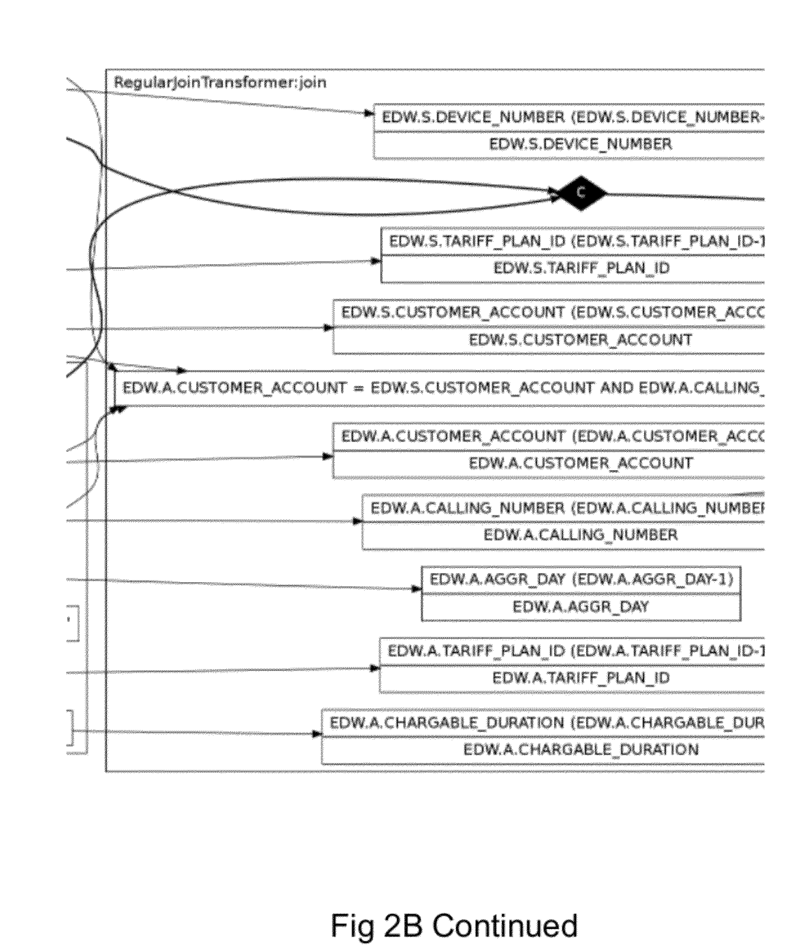

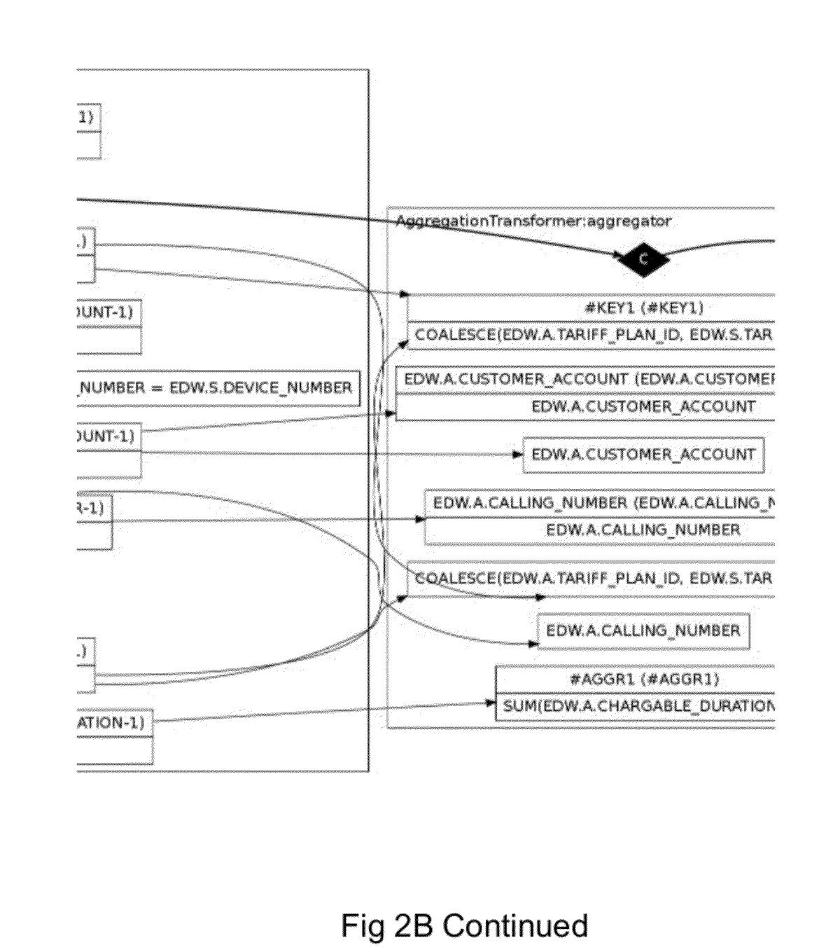

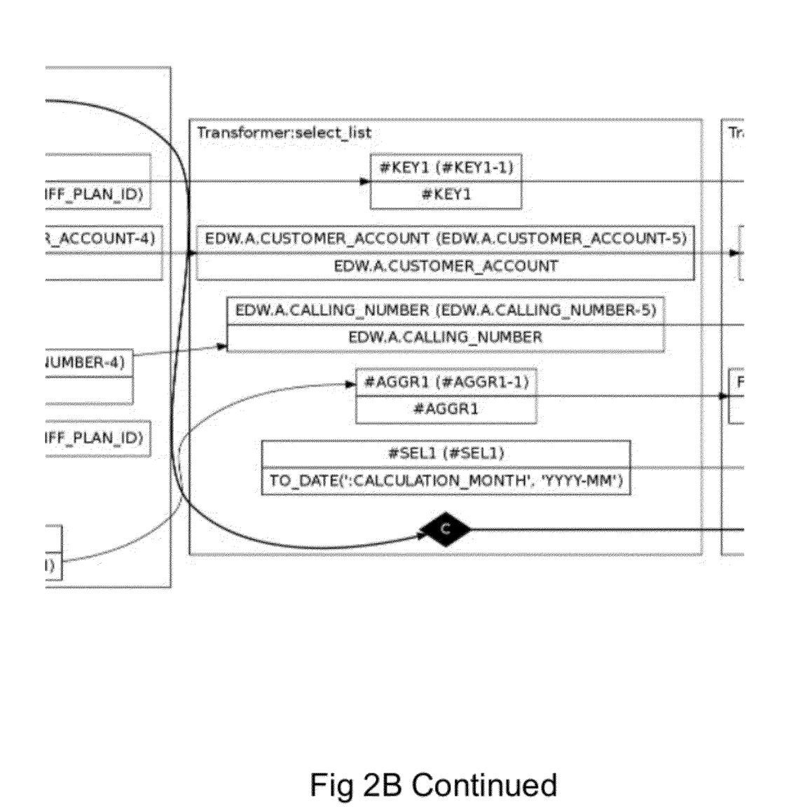

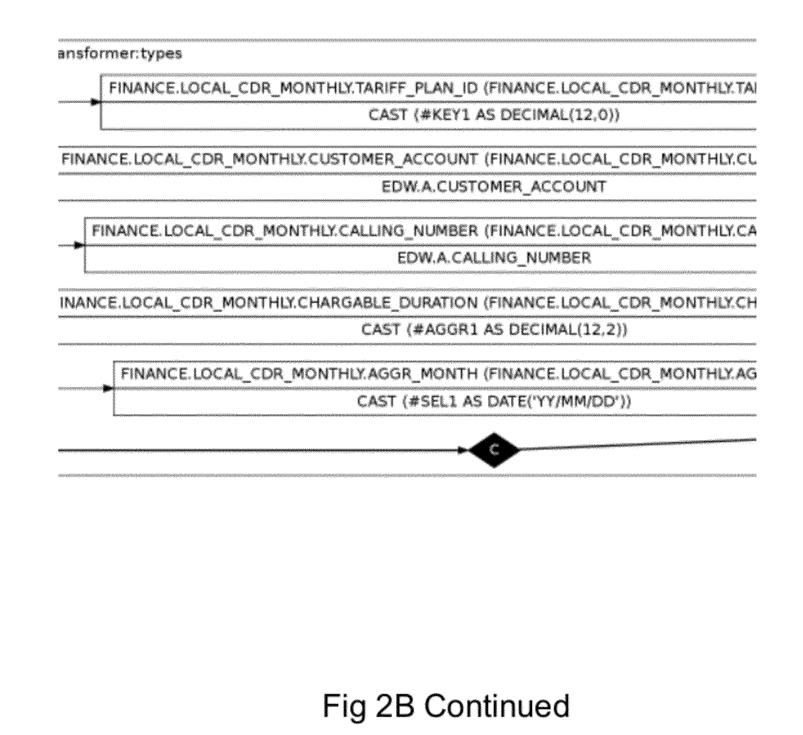

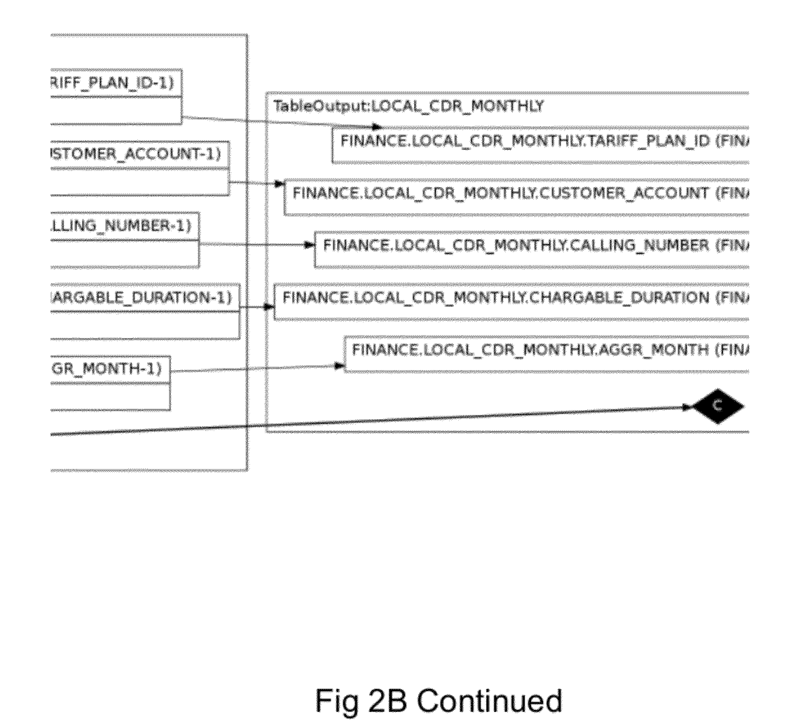

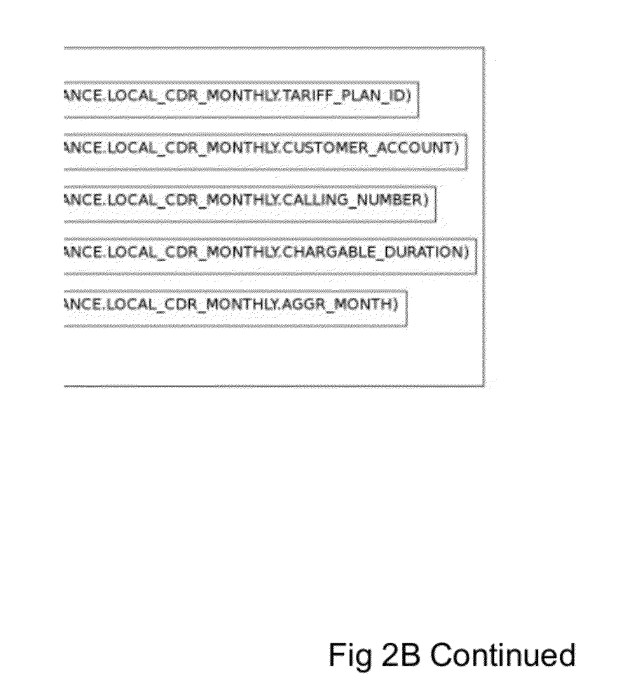

Example common metadata format object representing a sample data integration process has been presented on FIGS. 2A and 2B. FIG. 2A shows example of component level dependencies between common metadata format elements for a particular data integration application. FIG. 2B shows detailed relations between particular fields that are used in every calculation of the data integration application being analyzed. As skilled reader realizes the arbitrary graphical representation of the common metadata format is one possible implementation, other methods of building and presenting relations between the components and their fields are also available basing on the invention presented herein.

The input may be nearly any type of data integration or transformation application. For example, the input may be different types of ETL (“Extract, Transform, Load”), such as can be found in products including IBM DataStage, Informatica Power Center, Talend, or the like, all of which are hereby incorporated by reference. Under the ETL standard, dedicated data integration platforms are commonly used, and may take the form of special programs (called Jobs in Data Stage and Talend, Mappings in Informatica).

In another example, input may fall under the ELT (“Extract, Load, Transform”) standard. According to this standard, data is loaded to the target data base in the original form and then transformed inside the database using SQL queries. Still other standards may be used as input into the presently contemplated invention.

The processes may then be analyzed and different outputs generated, including processes translated into particular ETL platforms, SQL scripts, documentation, and metadata, in a format needed for particular metadata repository, etc. A skilled reader realizes, the invention enables one to efficiently convert the input processes into virtually any form of executable or non-executable representation of the input.

One significant advantage of the invention is the ability to combine different types of input. In one particular implementation, the ETL processes being analyzed may contain embedded SQL statements. Because the proposed processing method converts both the ETL process as well as the embedded SQL statements into the same common metaformat, the invention enables complete analysis of the processing logic including all the technologies engaged.

In some implementations, after building the initial representation of the input process(es) in form of the common metadata format, some further processing that enriches and/or modifies the meta format object(s) in a way that use desired for further processing can be applied. Such modification may include:
moving filters closer to the sources—if in the original data integration process there is a filter applied based on a value that has been already available significantly earlier in the data integration process, then the filter can be moved up the stream; the advantage of this is that the total amount of data that moves through the system is reduced;
merging consecutive aggregations or transformations—if the data integration process includes consecutive aggregations or consecutive transformations or other consecutive operations that can be merged together to improve the performance and/or readability of the data integration process being analyzed those components may be merged;
expression rewriting—in some cases the language of valid expressions in the source and target system (that depend on the source system and the desired output) will be different, in such a situation expressions translation step is required to transform all the expressions to the form required by the output system;
target specific pre-processing—some of the common metadata format components and/or constructions may not be supported by the target system, such components and/or constructions may be replaced by functionally equivalent patterns of components and/or constructions available in the target platform.

As a skilled reader realizes, the above list is not exhaustive but rather provides some examples from a wide range of possible modifications. One advantage of the fact of using a common metadata format to represent that data integration process is that all those modifications, regardless of their nature, require only a single implementation that does not depend on the given source and requested target, what gives significant improvements in the cost of implementation.

Depending on the desired output, the meta format representing the data integration process is analyzed and properly converted. In the case of generating a data integration process for particular platform, all of the components and expressions may get converted to the components and expressions available on the target platform. The process is then saved in the proper format. In the case of metadata extraction, the information about data assets being used and the data flow between them is extracted and saved in proper format. In the case of still other applications, like documentation generation, etc., proper information is once again extracted and saved in the appropriate format.

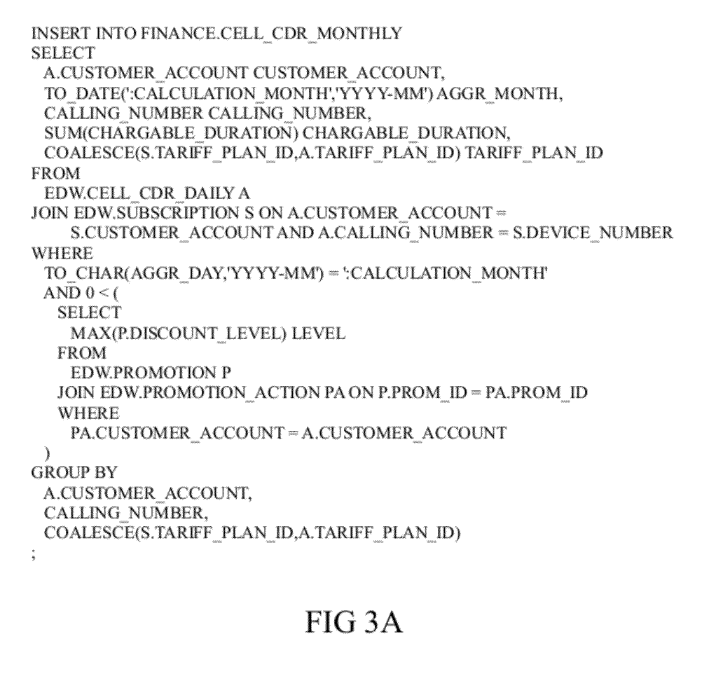

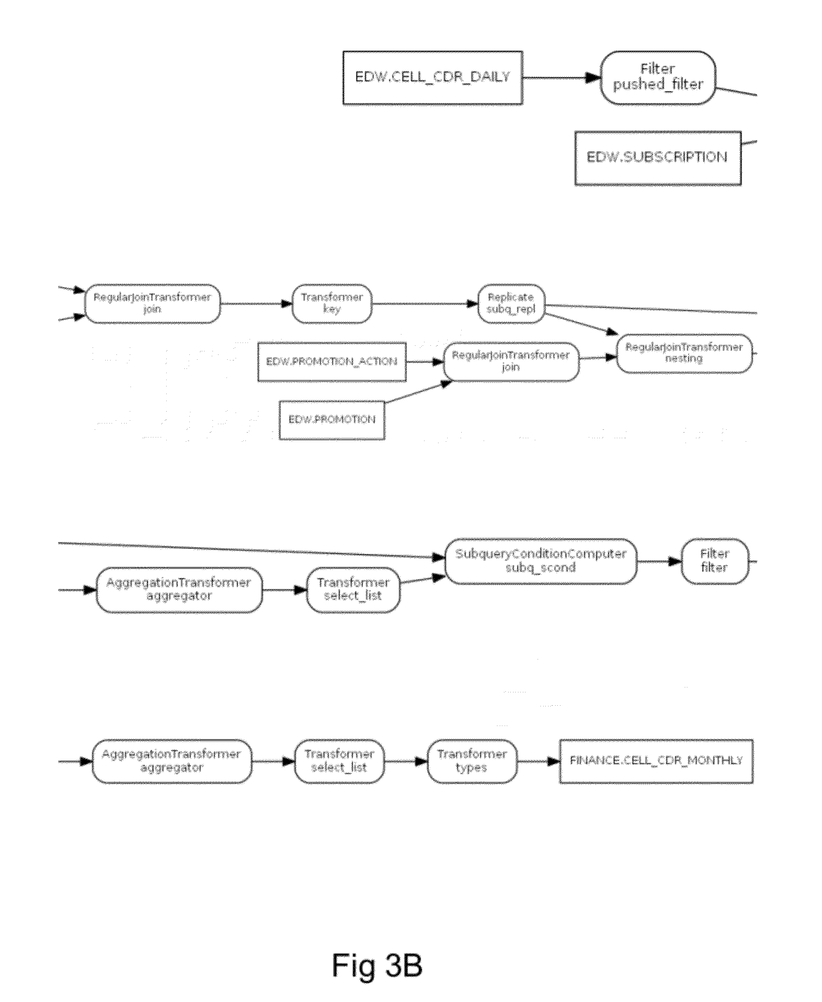

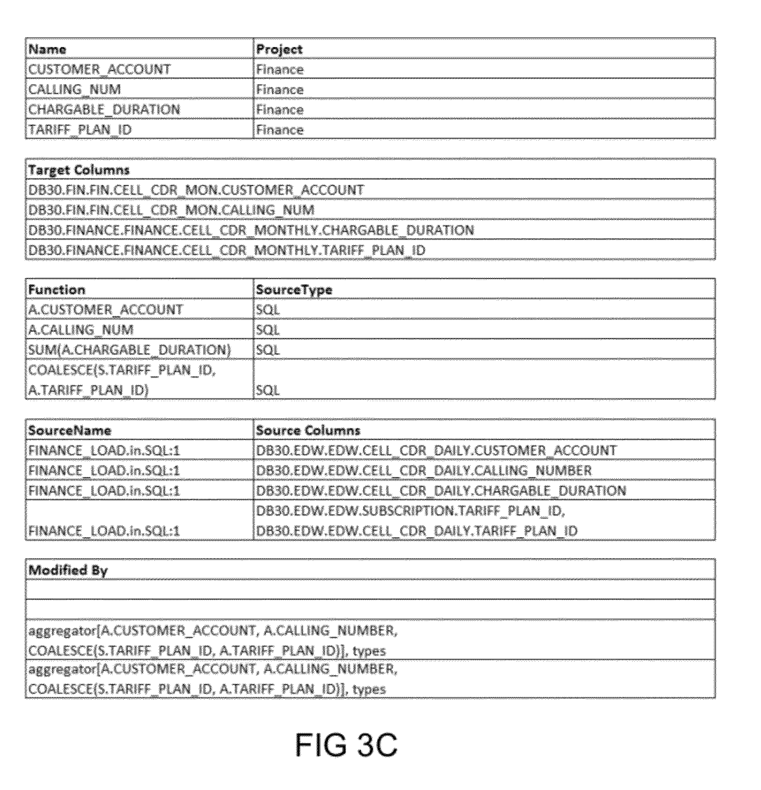

An example of the method using an SQL query as the input is visible in FIGS. 3A-3D. Specifically, FIG. 3A shows an example of what an SQL input may be. In FIG. 3B, the SQL input has been converted into the common metadata format. FIGS. 3C and 3D show different output examples that may be desired by the user. Specifically, FIG. 3C shows extracted metadata that can be imported into a metadata repository such as IBM Metadata Workbench, and FIG. 3D shows automatically generated documentation of the input SQL query.

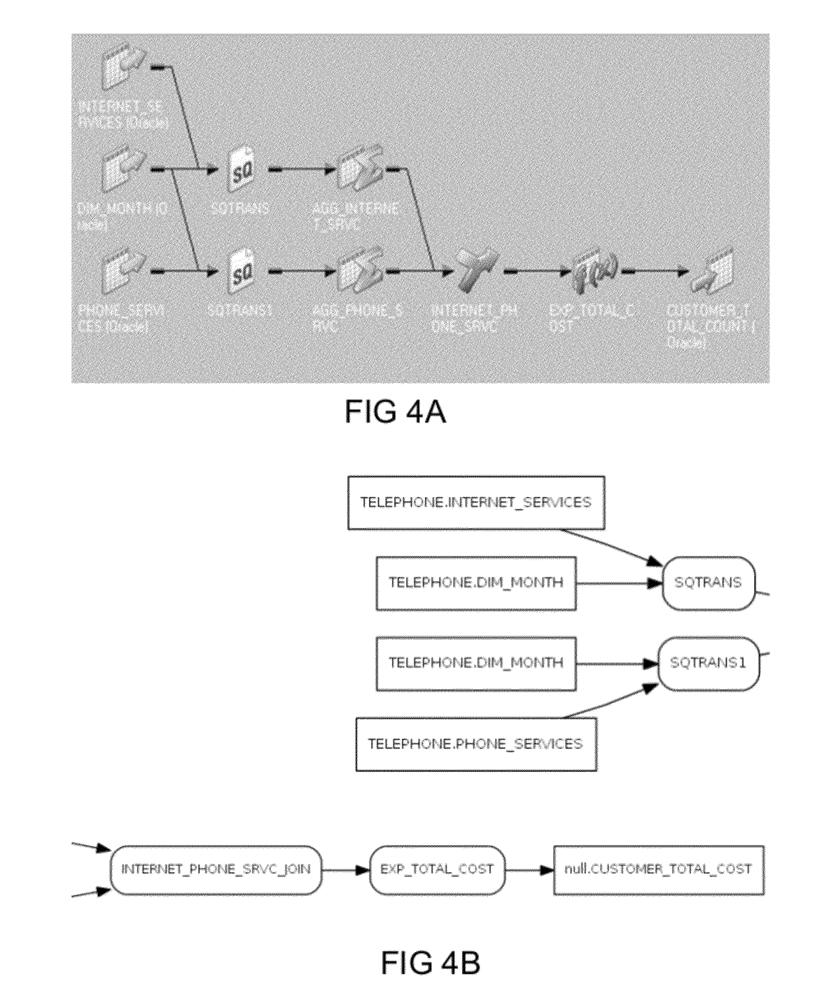

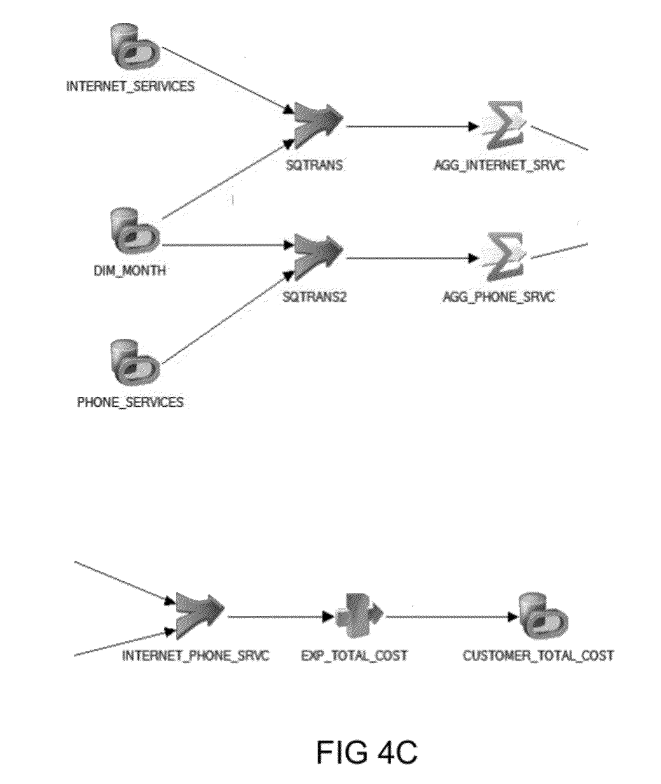

In yet another example, shown in FIGS. 4A-4C, an Informatica input format (FIG. 4A) is transformed into common metadata format (FIG. 4B), and then output into an IBM DataStage job. After conversion to IBM DataStage job, the original Informatica Mapping may be discarded if no longer needed.

One advantage of the presently disclosed invention is the generation of outputs other than data integration process. In contrast to reading a data integration process, generating intermediate representations, and then converting the representations to the target format, the contemplated method generates not only data processing jobs, but also other outputs like metadata describing the process, documentation, visualization etc.

Additionally, the presently disclosed invention can be applied not only to ETL data integration processes, but also to the ELT (SQL as well as database load and unload utilities), BI reporting processes, as well as other data integration processes. In contrast to SQL translators, which do not include a meta model that is capable of representing processes other then SQL, the presently contemplated solution can accommodate both ETL and ELT formats (or other formats)—even when they are intermixed.

Moreover, the level of details output from the disclosed invention exceed those found in prior art systems. Typical metadata integration systems such as Meta Integration Model Bridge from Meta Integration Technology offer metadata transfer capabilities between different solutions. However, the information being transferred is on the design level—it identifies the basic data flow but is not precise enough to fully rebuild the data integration process on another platform.

The metadata generated by the process disclosed herein may be used in various ways known in the industry. For example, the metadata can be used to perform data lineage, impact analysis, version comparison, and others.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by any appended claims.

A plurality of advantages arises from the various features of the present disclosure. It will be noted that alternative embodiments of various components of the disclosure may not include all of the features described yet still benefit from at least some of the advantages of such features. Those of ordinary skill in the art may readily devise their own implementations of a data integration process or application that incorporate one or more of the features of the present disclosure and fall within the spirit and scope of the disclosure.

1. A computer readable medium operable on a processing unit containing one or more instructions for automatically analyzing and migrating data integration applications, the computer readable medium employing the steps of:
parsing at least one existing data integration application to identify the metadata, extracting the metadata;
converting the metadata into a common metadata format; and
generating a desired output from the converted metadata.

2. The computer readable medium of claim 1, further comprising processing the metadata stored in a common metadata format.

3. The computer readable medium of claim 1, wherein the metadata comprises information associated with the at least one data integration application as well as information associated with the underlying data assets.

4. The computer readable medium of claim 1, wherein the data integration application comprises at least one of Extract-Transform-Load (ETL), Extract-Load-Transform (ELT), and a Business Intelligence (BI) format.

5. The computer readable medium of claim 1, wherein all of the converted metadata is stored in a single repository, independent of the metadata from the existing data integration application.

6. The computer readable medium of claim 1, wherein the instructions further comprise at least one of optimizing and transforming the converted metadata.

7. The computer readable medium of claim 1, wherein the output comprises an existing data integration application in a form needed by another provider's platform.

8. The computer readable medium of claim 1, wherein the output comprises a supporting documentation or visualization format.

9. The computer readable medium of claim 1, wherein the output comprises an alternate desired metadata format.

10. A software program for the migration of data integration applications implemented on a computer system, the software program comprising the steps of:
analyzing at least one existing data integration application;
converting the metadata associated with the at least one existing data integration application into a common metadata format;
storing all of the converted metadata in a single repository; and
generating a desired output from the converted metadata.

11. The software program of claim 10, wherein the step of converting further comprises the step of parsing the at least one existing data integration application.

12. The software program of claim 10, wherein the metadata comprises information associated with the at least one data integration application as well as information associated with the underlying data assets.

13. The software program of claim 10, wherein the analyzing, converting and generating steps occur automatically.

14. The software program of claim 10, wherein the data integration process comprises at least one format selected from the group comprising an Extract-Transform-Load (ETL), an Extract-Load-Transform (ELT), and a Business Intelligence (BI) format.

15. The software program of claim 10, wherein the output comprises a known data integration application format.

16. The software program of claim 10, wherein the output comprises a supporting documentation or visualization format.

17. The software program of claim 10, wherein the output comprises an alternate desired metadata format.

18. A computer software system for analyzing data integration applications executed by a computer system, the computer software system employing the steps of:
converting the metadata associated with one or more existing data integration application(s) into a common metadata format;
storing all of the converted metadata in a single repository; and
generating a desired output from the common metadata format.

19. The software program of claim 18, wherein the instructions further comprise optimizing or transforming the common metadata format.

20. The software program of claim 18, wherein the output comprises at least one of a known data integration application format, a supporting documentation format, a graphical visualization format, and an alternate desired metadata format.
